(19) United States
(12) Patent Application Publication
(10) Pub. No.: US 2026/0185415 A1
(43) Pub. Date: Jul. 2, 2026

(54) WELLHEAD APPARATUS LIFTING METHOD AND ASSOCIATED APPARATUS

(71) Applicant: WELLVENE LIMITED, Aberdeen (GB)

(72) Inventor: Bronson LARKINS, Aberdeen (GB)

(21) Appl. No.: 19/118,000

(22) PCT Filed: Oct. 2, 2023
(86) PCT No.: PCT/GB2023/052534

§ 371 Date: Apr. 3, 2025

(30) Foreign Application Priority Data
Oct. 3, 2022 (GB) 2214546.0

(51) Int. Cl. E21B 33/03; B66C 23/20; E21B 23/00

(52) U.S. Cl. CPC E21B 33/03; B66C 23/20; E21B 23/00

(57) ABSTRACT

A method of lifting a wellhead apparatus including a PCE. The method involves lifting the PCE using a PCE lifting apparatus with the PCE lifting apparatus being supported on the wellhead A connection in wellhead equipment can be broken, by lifting a portion of the wellhead equipment using the PCE lifting apparatus to break the connection. The PCE lifting apparatus is supported on the wellhead throughout lifting of the portion of the wellhead equipment.

### TECHNICAL FIELD

The present invention relates to a method of lifting a wellhead apparatus, particularly, but not exclusively, lifting a lubricator; and associated apparatus.

### BACKGROUND

Wellheads, such as for subsea oil/gas wellbores, have a number of valves for controlling flow or pressure in/from wellbores. In particular, producing wells have Xmas trees mounted at the wellhead, whereby production can be controlled and well fluids contained as desired or required.

Particularly where equipment can be safety-sensitive, caution is employed when inspecting, installing or maintaining equipment. Accordingly, wellhead workover or access systems, such as with wireline (or coiled tubing) are used in combination after pressure control equipment is fitted to the wellhead to ensure safety. Sequential lifts and valve closures are used in closely defined sequences to place equipment in the wellbore at the wellhead.

It may be an object of one or more aspects, examples, embodiments, or claims of the present disclosure to at least mitigate or ameliorate one or more problems associated with the prior art, such as described herein or elsewhere.

### SUMMARY

According to a first aspect, there is provided a method of lifting a wellhead apparatus. The method may comprise breaking a connection in a wellhead string or equipment. The wellhead apparatus may comprise a pressure control equipment (PCE), such as a lubricator. The method may comprise breaking the connection in wellhead equipment, the method comprising lifting a portion of the wellhead equipment using a wellhead equipment lifting apparatus wherein the lifting apparatus is supported on the wellhead. The wellhead equipment lifting apparatus may comprise a PCE lifting apparatus. The method may comprise lifting the PCE, such as a lubricator, using a bespoke PCE lifting apparatus configured specifically for lifting the PCE, or portion thereof. The PCE lifting apparatus may comprise a lubricator lifting apparatus. The PCE lifting apparatus may be supported on the wellhead. The PCE lifting apparatus may be entirely supported on the wellhead. The PCE lifting apparatus may be directly supported on the wellhead.

According to an aspect, in at least some examples, there may be provided a method of lifting a wellhead apparatus comprising a PCE; the method comprising lifting the PCE using a PCE lifting apparatus, with the PCE lifting apparatus being supported on the wellhead.

According to an aspect, in at least some examples, there may be provided a method of breaking a connection in wellhead equipment, the method comprising lifting a portion of the wellhead equipment using a wellhead equipment lifting apparatus wherein the lifting apparatus is supported on the wellhead. The wellhead equipment lifting apparatus may comprise any of the features of PCE lifting apparatus described herein.

The method/s may comprise supporting the PCE lifting apparatus on the wellhead such that the PCE or portion thereof can be lifted off the wellhead whilst the wellhead still bears the weight of the PCE or portion thereof during lifting and optionally thereafter. The method may comprise creating a separation between the PCE, or portion thereof, and the wellhead therebelow. The method may comprise creating a separation between the PCE, or portion thereof, and the wellhead therebelow whilst supporting the weight of the PCE, or portion thereof, on the wellhead. The method may comprise lifting the PCE, or portion thereof, without transferring weight of the PCE, or portion thereof, off the wellhead. The method may comprise lifting of the PCE, or portion thereof, without requiring compensation. The method may comprise lifting the PCE, or portion thereof, without any relative movement between the wellhead and the PCE lifting apparatus, or support/mounting thereof. The PCE lifting apparatus may comprise a support or mounting that is fixed relative to the wellhead through lifting.

The method may comprise supporting the lifting apparatus from below. The method may comprise lifting the PCE, or portion thereof, from below. The method may comprise supporting the PCE, or portion thereof, from below. The method may comprise lifting the PCE, or portion thereof, without suspending the PCE, or portion thereof. The method may comprise lifting the PCE, or portion thereof, without any suspension and/or swinging of the PCE, or portion thereof, such as from a flexible tensile member (e.g. cable, wire, rope or the like). The method may comprise lifting the PCE, or portion thereof, without requiring any flexible tensile members. The method may comprise lifting the PCE, or portion thereof, without any flexible tensile members.

The method may comprise supporting the PCE, or portion thereof, from below during lifting of the PCE, or portion thereof. The method may comprise supporting the PCE, or portion thereof, from below during lifting of the PCE, or portion thereof, and optionally thereafter. The method may comprise rigidly supporting the PCE, or portion thereof.

The method may comprise attaching the PCE lifting apparatus to the wellhead below a connection to be broken. The method may comprise additionally attaching the PCE lifting apparatus above the connection to be broken. Accordingly, the PCE lifting apparatus may be attached both above and below the connection to be broken. The upper attachment, above the connection, may be to the PCE, or at least equipment associated therewith, particularly to be lifted together with the PCE, or portion thereof, (e.g. a mini-riser or the like). The lower attachment, below the connection, may be to, at or around a BOP, Xmas tree, or the like.

The PCE lifting apparatus may remain attached above and below the connection being broken throughout the breaking of the connection. The PCE lifting apparatus may transfer at least a portion of the weight of the PCE, or portion thereof, after breaking of the connection to the wellhead. An entirety of the weight of the lifted PCE, or portion thereof, may be transferred through the PCE lifting apparatus to the wellhead.

The method may comprise moving the PCE, or portion thereof, off a central axis of the wellbore/wellhead. The method may comprise laterally translating the PCE, or portion thereof, away from a central longitudinal axis of the wellbore. The method may comprise moving the PCE, or portion thereof, off the centerline whilst maintaining the PCE, or portion thereof, upright. The method may comprise moving the PCE, or portion thereof, off the centreline without suspending the PCE, or portion thereof, such as from a crane, derrick, winch or the like. The method may comprise linearly translating the PCE, or portion thereof, in a lateral direction off the centre line. Additionally, or alternatively, the method may comprise rotating the PCE, or portion thereof, away from the centreline. The method may comprise rotating the PCE, or portion thereof, away from the centreline by rotating the PCE, or portion thereof, about a vertical axis parallel to the centreline, spaced therefrom. Accordingly, the PCE, or portion thereof, may be maintained vertical throughout. The method may comprise rotating the PCE, or portion thereof, away/towards the centre line whilst lifting. For example, the method may comprise a synchronised rotation and lift. The method may comprise driving the apparatus linearly and rotationally simultaneously, such as with a cam or the like. In at least some examples, the method may comprise driving a keyed piston, rotationally and/or linearly.

The method may comprise locking the PCE, or portion thereof. The method may comprise locking the PCE, or portion thereof, in a selected position. The method may comprise locking the PCE, or portion thereof, in a lifted position. The method may comprise locking the PCE, or portion thereof, in a lateral position, such as laterally moved off the centreline. The method may comprise locking the PCE, or portion thereof, in a rotated position, such as with the PCE, or portion thereof, rotated off the centreline. The method may comprise selectively locking the position in one or more positions. The method may comprise selecting a locked or locking position of the PCE, or portion thereof, from at least: a lifted position; and/or a lateral position. The method may comprise locking the PCE, or portion thereof, in a locked and lateral position, such as locking the PCE, or portion thereof, in a lifted/raised position with the PCE, or portion thereof, moved off the centreline. The method may comprise automatically locking the PCE, or portion thereof. Additionally or alternatively, the method may comprise manually locking the PCE, or portion thereof. The method may comprise directly and/or indirectly locking the PCE, or portion thereof. In at least some examples, the method comprises locking the lifting apparatus by which the PCE, or portion thereof, is lifted.

The method may comprise performing any one or more of the preceding steps in reverse so as to (re)place the PCE, or portion thereof, on the wellhead. The method may comprise reversing steps so as to (re)place the PCE, or portion thereof, on the wellhead. For example, the PCE, or portion thereof, may be moved (e.g. translated) (back) on to the centreline; and then lowered for connection to the wellhead. The method may comprise unlocking the PCE, or portion thereof.

The method may comprise accessing a well. The method may comprise accessing a wellbore. The method may comprise a method of accessing a wellhead. In at least some examples, the method may comprise performing an operation, changeout and/or intervention. In at least some examples, the method may comprise inspecting and/or servicing and/or (re)placing a valve.

The method/s of the present disclosure may not require supporting the PCE, or portion thereof, on the deck, such as using a deck-mounted crane, derrick, winch or the like.

The method may comprise supporting the weight of an entirety of the PCE, or portion thereof, on the wellhead throughout lifting.

The method may comprise lifting the PCE lifting apparatus onto the wellhead in a single lift operation. In at least some examples, the method may comprise connecting the apparatus to a lifting apparatus, such as a winch, derrick, crane or the like (e.g. an additional or external lifting apparatus, such as a deck-based lifting apparatus that is relatively movable with respect to the wellhead). The method may comprise a single-lift operation. The lifting apparatus may be a light lifting apparatus, such as relatively lighter than for lifting or supporting a conventional crane or the like. The method may comprise transferring the apparatus between wells/wellheads without being fully rigged down. The method may comprise lifting the apparatus from a wellhead in a single lift. The method may comprise lifting the apparatus from a first wellhead to another wellhead in a single lift. The method may comprise lifting the apparatus directly from a first wellhead to a second wellhead. The method may comprise lifting the apparatus from a first wellhead to a stored position, particularly a vertical stored position of the PCE lifting apparatus.

The method may comprise access to the wellbore. The method may consist of near-surface operations. Near-surface access may comprise access at or above/uphole of a sub-surface safety valve. Near-surface access may comprise access to only the wellbore at or above/uphole from the sub-surface safety valve. Near-surface may comprise up to and including a maximum depth of a SSV. The method may comprise accessing the wellbore proximal the wellhead. Proximal to the wellhead may comprise within 100 metres, respectively 50 metres, respectively 20 metres, 10 metres, 5 metres or less.

The method may comprise providing pressure control equipment. The method may comprise accessing the well with a tool. The tool may comprise one or more of: an intervention tool; an inspection tool; a run-in tool.

The method may comprise a lifting operation without suspending or suspensively supporting equipment, such as the PCE, or portion thereof, and/or a toolstring, in or above the wellbore during the well access operation. In at least some examples, the only (suspensive) lifting operation is a lift, such as single lift, of the PCE lifting apparatus into position prior to commencement of the PCE lifting operation. The method may comprise supporting all of the weight of the PCE, or portion thereof, and a toolstring on the wellhead throughout. For example, the method may comprise supporting the weight of the lifted PCE, or portion thereof, with the PCE, or portion thereof, off-center; and also supporting the weight of a toolstring on the centreline-all supported entirely on the wellhead.

The method may comprise a lifting device with or on the PCE lifting apparatus. The lifting device may be for lifting a tool, toolstring or portion thereof. The method may comprise lifting a tool, toolstring or portion thereof, with the weight of the tool, toolstring or portion being lifted supported on or by the apparatus. The lifting device may be for supporting at least one of: wireline; slickline; e-line; coiled tubing. The lifting device may form part of the apparatus such that when the apparatus is supported on the wellhead, the lifting device is also supported on the wellhead. Accordingly, the lifting device of the apparatus may enable lifting of the tool or toolstring without use or requirement of an external lifting apparatus, such as a crane, derrick, mast or the like as otherwise previously required prior to the present invention. The lifting device of the apparatus may comprise one or more of: a sheave, winch, reel or the like. It will be appreciated that in other examples, a tool/line-lifting device can be provided discretely from the apparatus-such as supported/mounted on the PCE lifting apparatus as such. In at least some examples, the lifting device may be directly mounted to or on the PCE itself. For example, the lifting device may be mounted to or on the lubricator itself, to allow suspension of tools adjacent to the lubricator. The lifting device may be mounted to the PCE itself so as to allow lifting of tools or toolstrings when the PCE is laterally moved off the central axis of the wellhead. The lifting device may be mounted to the PCE itself so as to allow lifting of tools or toolstrings on the axis for insertion/removal to/from the wellhead. It will be appreciated that lifting may entail raising and/or lowering. For example, a lifting operation may comprise lowering the PCE, such as the lubricator, onto the wellhead.

The method may comprise temporarily mounting the PCE lifting apparatus to the wellhead (e.g. to the PCE, or portion thereof). The method may comprise temporarily mounting the lifting device (for lifting the toolstring) to the wellhead (e.g. to the PCE, or portion thereof). The method may comprise retrofitting the PCE lifting apparatus to the wellhead (e.g. to the PCE, or portion thereof). The method may comprise retrofitting the lifting device (for lifting the toolstring) to the wellhead (e.g. to the PCE, or portion thereof). The method may comprise mounting the PCE lifting apparatus and/or the lifting device thereof to a plurality of wellheads. For example, the method may comprise mounting the PCE lifting device to a first wellhead; performing a first lifting operation; and then transferring the PCE lifting device to a second wellhead for performance of a second lifting operation.

According to an aspect, there is provided a method of lifting at least a portion of tool or toolstring at or on a wellhead. The tool or toolstring may comprise an intervention tool or toolstring. The method may comprise lifting the portion of tool or toolstring with a lifting device supported on the wellhead. The method may comprise lifting the portion of tool or toolstring with a lifting device supported on the wellhead. The method may comprise supporting all of the weight of the PCE, or portion thereof, and a toolstring on the wellhead throughout. For example, the method may comprise supporting the weight of the lifted PCE, or portion thereof, with the PCE, or portion thereof, off-center; and also supporting the weight of a toolstring on the centreline-all of the lifted PCE (portion) and lifted toolstring being supported entirely on the wellhead. The method may comprise temporarily mounting the lifting device (for lifting the toolstring) to the wellhead (e.g. to the PCE, or portion thereof).

According to an aspect there is provided an apparatus for lifting a PCE, or portion thereof. The PCE, or portion thereof, may comprise a lubricator. The apparatus may be configured to replace a suspension of a PCE, or portion thereof, from above. The apparatus may be configured to perform any of the abovementioned features of the preceding or any other aspect, embodiment, example or claim.

The apparatus may comprise a fitting, such as a clamp, for connection to the wellhead. The apparatus may be configured to be connected to the wellhead and/or a Xmas tree and/or a BOP. In at least some examples, the apparatus may comprise a fitting on the lower/downhole end/portion for attachment to the wellhead below the PCE, or portion thereof. Additionally, the apparatus may comprise a fitting, such as a clamp, for connection to the PCE, or portion thereof, or at least a portion of the wellhead to be lifted with the PCE, or portion thereof. The apparatus may be configured to be connected to the PCE, or portion thereof, directly. Additionally or alternatively, the apparatus may be configured to be connected to the PCE, or portion thereof, indirectly, such as via other equipment attached thereto to be lifted (e.g. a mini-riser, stuffing box or the like). In at least some examples, the apparatus may comprise a fitting on the upper/uphole end/portion for attachment to the PCE, or portion thereof. Accordingly, the PCE lifting apparatus may be configured to be attached to the wellhead below the PCE, or portion thereof, via a first, lower fitting; and attached to the PCE, or portion thereof, above the wellhead via a second, upper fitting. The PCE lifting apparatus may thereby be attached to the wellhead below a connection to be broken to lift the PCE, or portion thereof; and also above the connection, to the PCE, or portion thereof. Each fitting may comprise at least a pair of attachment members, such as a pair of clamps.

The apparatus may comprise a hydraulic actuator. The hydraulic actuator may comprise a piston. The apparatus may comprise a cylinder housing the piston. The cylinder may be fixably mounted to the wellhead. The cylinder may form an exterior housing of the PCE lifting apparatus. The cylinder may comprise a hydraulic cylinder. The lower portion of the piston may be connected to the wellhead. The PCE lifting apparatus may be attached to the wellhead below the PCE, or portion thereof. The PCE lifting apparatus may be attached to the wellhead at at least two discrete positions below the PCE, or portion thereof, (to be lifted).

The apparatus may be configured to prevent or at least control rotation of the piston/s. The apparatus may be configured to actively control a rotational position of the piston. The apparatus may be configured to rotationally drive the piston to change an orientation of the piston, such as to move the position horizontally relative to the longitudinal axis of the piston. The apparatus may be configured to synchronously rotate and lift. The apparatus may be configured to synchronously rotate and lift In at least some examples, the piston/s may be keyed to combine rotation and lifting, such as to follow a helical or spiral path. Additionally or alternatively, the piston/s may be keyed to prevent rotation about the longitudinal axis, along at least a portion of longitudinal travel. For example, the key may restrict movement to vertical along a first portion of lifting travel along a vertical keyway or path; and then a portion of spiral or helical keyway or path may be followed to provide rotation relative to the central longitudinal axis of the wellhead. The apparatus may be configured to control a longitudinal position of the piston/s. The apparatus may be configured to detect and/or measure a longitudinal and/or rotational position of a portion of the apparatus, such as of the piston/s and/or PCE, or portion thereof, associated therewith.

The apparatus may comprise a sensor for sensing a position of the piston and/or the PCE, or portion thereof, (e.g. relative to the wellhead). The position may comprise a longitudinal position of the piston and/or the PCE, or portion thereof. Additionally or alternatively the position may comprise a longitudinal position of the piston and/or the PCE, or portion thereof. The sensor/s may be configured to detect an operation of the apparatus, such as a correct operation. The sensor/s may be configured to provide an indication of a position of the apparatus, such as a position of a portion of the apparatus (e.g. the piston). The position may comprise a longitudinal position, such as a longitudinal position relative to another portion of the apparatus. The sensor/s may comprise an axial sensor. The sensor/s may be configured to measure a separation between or to a piston face, such as an end face. The sensor/s may comprise a contactless sensor/s, such as a laser or optical sensor, and/or an electromagnetic sensor. The sensor/s may comprise an electronic sensor/s. The sensor/s may comprise a mechanical sensor.

The apparatus may comprise a support, such as a support frame. The support may be for supporting the PCE lifting apparatus and/or the PCE, or portion thereof. The support may be provided with the apparatus, such as part of or at least connected or mounted to the PCE lifting apparatus. In at least some examples, the apparatus comprises a support frame for supporting the PCE lifting apparatus when disconnected from the wellhead.

The apparatus may comprise a lifting device. The lifting device may be for lifting a tool, toolstring or portion thereof. The lifting device may be for supporting at least one of: wireline; slickline; e-line; coiled tubing. The lifting device may form part of the apparatus such that when the apparatus is supported on the wellhead, the lifting device is also supported on the wellhead. Accordingly, the lifting device of the apparatus may enable lifting of the tool or toolstring without use or requirement of an external lifting apparatus, such as a crane, derrick, mast or the like as otherwise previously required prior to the present invention. The lifting device of the apparatus may comprise one or more of: a sheave, winch, reel or the like. It will be appreciated that in other examples, a tool/line-lifting device can be provided discretely from the apparatus—such as supported/mounted on the PCE lifting apparatus as such. In at least some examples, the lifting device may be directly mounted to or on the PCE itself. For example, the lifting device may be mounted to or on the lubricator itself, to allow suspension of tools adjacent to the lubricator. The lifting device may be mounted to the PCE itself so as to allow lifting of tools or toolstrings when the PCE is laterally moved off the central axis of the wellhead. The lifting device may be mounted to the PCE itself so as to allow lifting of tools or toolstrings on the axis for insertion/removal to/from the wellhead. The lifting device may comprise a direct lifting device, such as a powered winch or the like. Additionally, or alternatively, the lifting device may comprise an indirect lifting device, such as an unpowered lifting device (e.g. sheave, pulley, etc.) that is connected or connectable to a further lifting device (e.g. a secondary, powered lifting device).

The apparatus may be configured for operation/control remotely from the apparatus. The apparatus may be operable from a control unit spaced from the apparatus, such as a deck-based control unit spaced from the wellhead. The control unit may comprise a power supply or pack for powering the apparatus (e.g. electrically and/or hydraulically). The control unit may be configured to operate the apparatus (e.g. hydraulic piston) and/or to convey/record information (e.g. position, weight, forces associated with the PCE, or portion thereof,). The control unit may be hard-wired to the apparatus. Additionally or alternatively, the control unit may be wirelessly connected to the apparatus.

According to an aspect, there is provided an assembly comprising apparatus according to any other aspect, example, embodiment or claim. The apparatus may additionally comprise one or more of: a PCE lifting apparatus; PCE; a lubricator lifting apparatus; a lifting device mounted or mountable to the apparatus and/or wellhead equipment, such as a portion of PCE; a lubricator, a riser or mini-riser, a BOP; valve; and/or shear and seal.

According to an aspect there is provided a transportation and/or storage unit for transporting and/or storing the apparatus of any other aspect, example, embodiment or claim. The transportation and/or storage unit may comprise a basket, such as a cargo basket. The basket may comprise conventional or standard outer dimensions for the oil/gas industry, such as similar outer dimensions to existing cargo baskets. The basket may comprise the PCE lifting apparatus.

According to an aspect, there is provided a system comprising a controller according to an aspect, claim, embodiment or example of this disclosure, or a system arranged to perform a method according to an aspect, claim, embodiment or example of this disclosure. The controller may be configured to control an operation, such as of the PCE lifting apparatus.

According to an aspect, there is provided computer software which, when executed by a processing means, is arranged to perform a method according to aspect, claim, embodiment or example of this disclosure. The computer software may be stored on a computer readable medium. The computer software may be tangibly stored on a computer readable medium. The computer readable medium may be non-transitory.

Any controller or controllers described herein may suitably comprise a control unit or computational device having one or more electronic processors. Thus, the system may comprise a single control unit or electronic controller or alternatively different functions of the controller may be embodied in, or hosted in, different control units or controllers. As used herein the term “controller” or “control unit” will be understood to include both a single control unit or controller and a plurality of control units or controllers collectively operating to provide any stated control functionality. To configure a controller, a suitable set of instructions may be provided which, when executed, cause said control unit or computational device to implement the control techniques specified herein. The set of instructions may suitably be embedded in said one or more electronic processors. Alternatively, the set of instructions may be provided as software saved on one or more memory associated with said controller to be executed on said computational device. A first controller may be implemented in software run on one or more processors. One or more other controllers may be implemented in software run on one or more processors, optionally the same one or more processors as the first controller. Other suitable arrangements may also be used.

Within the scope of this application it is expressly intended that the various aspects, embodiments, examples and alternatives set out in the preceding paragraphs, in the claims and/or in the following description and drawings, and in particular the individual features thereof, may be taken independently or in any combination. That is, all embodiments and/or features of any embodiment can be combined in any way and/or combination, unless such features are incompatible. The applicant reserves the right to change any originally filed claim or file any new claim accordingly, including the right to amend any originally filed claim to depend from and/or incorporate any feature of any other claim although not originally claimed in that manner.

The invention includes one or more corresponding aspects, embodiments or features in isolation or in various combinations whether or not specifically stated (including claimed) in that combination or in isolation. For example, it will readily be appreciated that where features are described with respect to a lubricator or lubricator lifter, such features are also disclosed for other wellhead equipment, such as other PCE. For example, where the lifting apparatus is described as lubricator lifting apparatus connected to a lubricator, such apparatus can be PCE lifting apparatus for lifting additional or alternative PCE (e.g. attached directly or indirectly to a BOP for the lifting thereof). Likewise, it will readily be appreciated that features recited as optional with respect to the first aspect may be additionally applicable with respect to the other aspects without the need to explicitly and unnecessarily list those various combinations and permutations here (e.g. the apparatus or device of one aspect may comprise features of any other aspect). Optional features as recited in respect of a method may be additionally applicable to an apparatus or device; and vice versa.

In addition, corresponding means for performing one or more of the discussed functions are also within the present disclosure.

The above summary is intended to be merely exemplary and non-limiting.

Various respective aspects and features of the present disclosure are defined in the appended claims.

It may be an aim of certain embodiments of the present disclosure to solve, mitigate or obviate, at least partly, at least one of the problems and/or disadvantages associated with the prior art. Certain embodiments may aim to provide at least one of the advantages described herein.

### BRIEF DESCRIPTION OF THE DRAWINGS

Elements of the present disclosure will now be described by way of example only and with reference to the accompanying drawings, in which:

FIG. 1 shows an example of a lubricator lift operation, not forming part of the present invention;

FIG. 2 shows a first apparatus according to an example of the present disclosure;

FIG. 3 shows the apparatus of FIG. 2 with a lubricator lifted;

FIG. 4 shows the apparatus of FIG. 2 with the lubricator lifted and moved off the wellbore axis;

FIG. 5 shows a side view of FIG. 4;

FIG. 6 shows a second apparatus according to an example of the present disclosure;

FIG. 7 shows the apparatus of FIG. 6 with a lubricator lifted;

FIG. 8 shows the apparatus of FIG. 6 with the lubricator lifted and moved off the wellbore axis;

FIG. 8b shows the apparatus of FIG. 8 with an auxiliary lifting device added;

FIG. 9a shows a third apparatus according to an example of the present disclosure;

FIG. 9b shows the apparatus of FIG. 9a with a lubricator lifted;

FIG. 9c shows the apparatus of FIG. 9a with the lubricator lifted and moved off the wellbore axis;

FIG. 9d shows a side view of FIG. 9c;

FIG. 10a shows the apparatus of FIG. 9a in a ¾ view;

FIG. 10b shows the apparatus of FIG. 9b in a ¾ view;

FIG. 10c shows the apparatus of FIG. 9c in a ¾ view;

FIG. 11a shows a fourth apparatus according to an example of the present disclosure;

FIG. 11b shows the apparatus of FIG. 11a with a lubricator lifted;

FIG. 11c shows the apparatus of FIG. 11a with the lubricator lifted and moved off the wellbore axis;

FIG. 11d shows a side view of FIG. 11a;

FIG. 12a shows the apparatus of FIG. 11a in a ¾ view;

FIG. 12b shows the apparatus of FIG. 11b in a ¾ view;

FIG. 12c shows the apparatus of FIG. 11c in a ¾ view;

FIG. 13a shows a fifth apparatus according to an example of the present disclosure;

FIG. 13b shows the apparatus of FIG. 13a with a lubricator lifted;

FIG. 13c shows the apparatus of FIG. 13a with the lubricator lifted and moved off the wellbore axis;

FIG. 13d shows a side view of FIG. 13c;

FIG. 14a shows the apparatus of FIG. 9a in a ¾ view;

FIG. 14b shows the apparatus of FIG. 9b in a ¾ view; and

FIG. 14c shows the apparatus of FIG. 9c in a ¾ view;

FIG. 15 shows an example method;

FIG. 16 shows an overview of a lifting/rotation system;

FIG. 17a shows a first portion of apparatus;

FIG. 17b shows a second portion of apparatus;

FIG. 17c shows assembled portions of apparatus; and

FIG. 18 shows an example of assembled apparatus at a wellhead.

### DETAILED DESCRIPTION

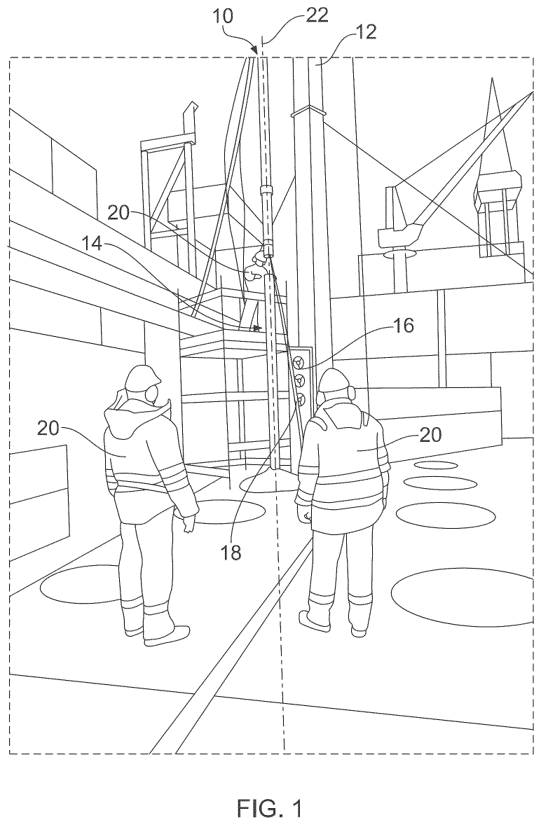

FIG. 1 shows an example of a lubricator lifting operation not forming part of the present invention. Here, the lubricator 10 is lifted by suspension via a cable (not visible, off top of image) from a (temporary) crane 12. The lubricator 10 is shown lifted clear of the wellhead 14, shown here with a BOP 16. The lower portion of the lubricator 10 is tethered by various tensile members 18 to control the position of the lubricator 10, such as to mitigate swinging of the lubricator 10. Wellhead personnel 20 oversee the operation, controlling the crane 12, tensile members 18 and operation of the lubricator lift.

The lubricator 10 can be lifted on to the wellhead 14 (e.g. initially) and/or lifted off the wellhead 14. In an example operation, the crane 12 is erected adjacent the wellhead 14 with the lubricator 10 installed thereon, mounted to the BOP 16. It will be appreciated that the wellhead 14 is equipped with safety equipment such as BOPs, Xmas tree, as appropriate to stage of well (e.g. drilling, completion, production, etc.). The lubricator 10 may be present at one or more stages of operation of the well. A top portion (not visible in FIG. 1) of the lubricator 10 is connected to the crane 12 via a suspensive cable (also not visible); and the tensile members 18 are attached to tether the lubricator 10 (e.g. to the deck, crane, fixings, etc.). The cable from the crane 12 is tensioned to support the lubricator 10 whilst the lubricator is disconnected from the wellhead 14 (e.g. by unscrewing connections thereto). The crane's 12 cable is then adjusted to lift the lubricator 10 off the wellhead 14, such as to the position shown in FIG. 1. Once lifted, the lubricator 10 can be moved laterally, off the wellbore central axis 22, such as swung by the crane 12 and/or tensile members 18. Accordingly, access can be gained to the wellhead 14, BOP 16 and the wellbore, such as for insertion/removal of equipment. In at least some examples, the crane 12 is also used to suspend equipment for insertion/removal in/from the wellbore; whereby the lubricator 10 may be temporarily supported or stored elsewhere. It will be appreciated that, when installed, the lubricator 10 can be used to allow, for example, a wireline tool string to be raised above the wellhead valve, enabling entry/exit from the well bore. It will also be appreciated that other Pressure Control Equipment can be provided for controlling pressure; and that appropriate valves can be closed (or opened) as necessary during the operations. Additional or alternative operations can include inspection and/or maintenance, such as inspection and repair or replacement of equipment (e.g. valves and/or the lubricator 10 itself) as necessary. Once access is no longer required to the wellbore with the lubricator lifted off the wellbore central axis 22, the lubricator 10 lifting process can be reversed, with the crane 12 suspending the lubricator 10 and lowering it 10 back onto the wellhead 14 for connection thereto-and subsequent (re)pressurisation.

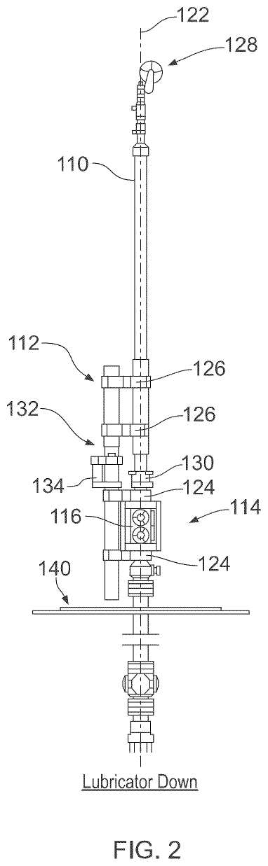

Turning now to FIG. 2, there is shown an example of an apparatus for performing a PCE lifting method according to the present invention. In the example shown here, the portion of PCE to be lifted includes a lubricator 110. Here the lifting of the lubricator 110 is performed without any suspension of the lubricator 110 from a tensile member.

Accordingly, the lubricator 110 does not require tethering with tensile members, in contrast to the method shown in FIG. 1. It is of course still possible to tether the lubricator 110. However, the lubricator 110 lifting method shown here precludes swinging of the lubricator 110 as a suspended load, since the lubricator 110 is rigidly supported throughout, particularly from below. Accordingly, it is not required to tether the lubricator 110 during lifting; and safety can be improved during lifting of the lubricator 110 by avoiding risks associated with suspended loads, such as swinging of the lubricator 110 (onshore or offshore)-noting also that personnel are not required to tether the lubricator 110 or adjust tethers during the lifting of the lubricator 110.

Referring first to FIG. 2, there is shown a wellhead apparatus positioned above a wellhead 114 fitted with a BOP 116 in the example shown. Here, the wellhead apparatus includes the lubricator 110. The wellhead apparatus here comprises a guide member 128 in the form of an end sheave. When the lubricator 110 is in use (e.g. for intervention operations, wireline operations or the like, not shown), wireline can be fed via the sheave and an end axial opening, through a stuffing box to connect with a tool within an inner chamber of the lubricator 110 of the wellhead apparatus. It will be appreciated that the lubricator 110 can form part of Pressure Control Equipment (PCE), such as with a combi blow out preventer, mini riser, auxiliary gate valve and a compact shear and seal valve (by way of example).

In the example here, the PCE lifting apparatus is shown as a lubricator lifting apparatus 112. The lubricator lifting apparatus 112 comprises a wellhead attachment, shown here in the form of a pair of lower clamps 124. The clamps 124 connect the lubricator lifting apparatus 112 to the wellhead 114, with the weight of the lubricator lifting apparatus 112 being supported by the wellhead 114, via force transfer through the clamps 124. Here, the clamps 124 are shown above and below the BOP 116. The lubricator lifting apparatus 112 is attached so that it is supported on the wellhead 114, below the connection to be broken. Accordingly, the lubricator lifting apparatus 112 is supported by the wellhead 114, connected thereto below the lubricator 110. In at least some examples, the lubricator lifting apparatus 112, or at least a portion of the attachment means, may form part of the wellhead apparatus, such as being integrally-formed or permanently attached thereto, such as with a BOP, shear/seal valve, mini-riser or the like. Additionally or alternatively, the lubricator lifting apparatus may be retrofitted to existing wellheads. Here, the lubricator lifting apparatus 112 comprises a lubricator attachment, shown in this example in the form of a pair of upper clamps 126 for connecting the lubricator lifting apparatus 112 to the lubricator 110. It will be appreciated that the attachment of the lubricator lifting apparatus 112 to the lubricator 110 can be directly to the lubricator 110 or via another portion of the wellhead apparatus that is or can be also lifted together with the lubricator 110, such as a portion of riser or the like.

With the lubricator rigidly supported by the lubricator lifting apparatus 112, the connection 130 between the (upper portion of the wellhead apparatus comprising the) lubricator 110 can be broken. This can be performed by personnel with the reassurance that the lubricator 110 cannot swing or move unpredictably as can be the case in conventional operations whereby the lubricator 110 is suspensively supported during lifting operations. In at least some examples, the lubricator lifting apparatus 112 comprises a means for breaking or disconnecting the lubricator 110 from the wellhead 114 therebelow, such as a rotational drive for unscrewing a connection therebetween. It will be appreciated that the lubricator lifting apparatus 112 can also be useful in (re)connecting the lubricator 110 to the wellhead 114 therebelow (e.g. by reversing rotational drive to make the screwed connection when it is desired to (re)attach the lubricator 110).

Having the lubricator lifting apparatus 112 mounted directly on the wellhead 114, supported thereby, avoids using up footprint on the deck 140 at or near the wellhead for a disparate deck-supported lubricator lifting apparatus, such as the crane 12 shown in FIG. 1. In contrast to conventional lubricator lifting operations, the lubricator lifting apparatus 112 itself is mounted directly on the wellhead 114. Accordingly, there is no requirement for discrete lifting devices mounted elsewhere, such as on the deck. Here, the lubricator lifting apparatus 112 does not require additional deck footprint: all of the apparatus 112 is mounted on the wellhead.

Accordingly, at least some example methods comprise lifting a lubricator 110, whereby the weight of an entirety of the lubricator 110 is supported on the wellhead-with or via the lubricator lifting apparatus 112. The lifting method here effectively maintains weight support of the lubricator 110 by the wellhead whilst creating a clearance or separation between the lubricator 110 and the wellhead 114 therebelow.

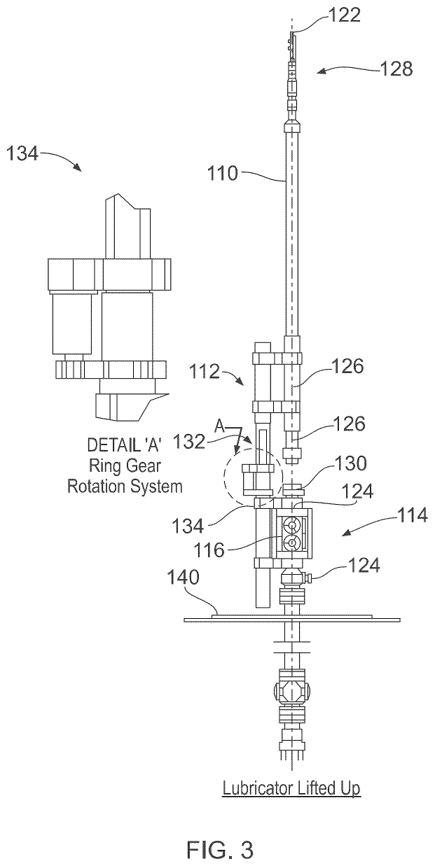

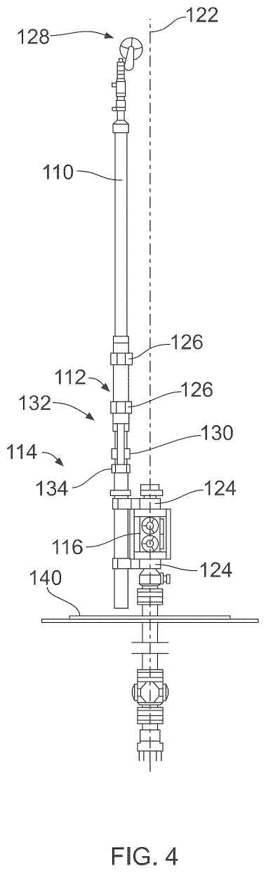

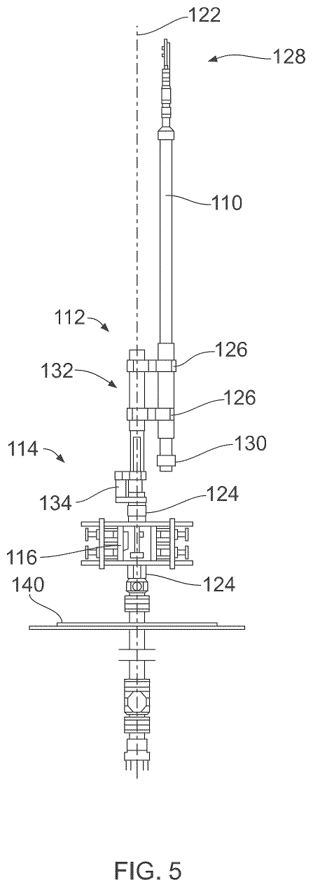

The lubricator lifting apparatus 112 comprises a piston 132 for selectively extending the lubricator attachment portion. The stroke of the piston 132 can be controlled to axially position the lubricator 110 attached thereto. Accordingly, the lubricator 110 can be lifted off the wellhead 114 (as shown sequentially in the transition from FIG. 2 to FIG. 3). In an example operation, the lubricator lifting apparatus 112 is attached to the wellhead 114, such as mounted to the BOP 116. The lubricator lifting apparatus 112 is attached to the lubricator 110, such as via the clamps 126 to a mini-riser associated with the lubricator 110. The piston 132 supports the weight of the lubricator 110 whilst the lubricator 110 is disconnected from the wellhead 114 (e.g. by unscrewing the connection 130 thereto). The piston 130 is then controlled to lift the lubricator 110 clear off the wellhead 114, such as to the position shown in FIG. 3. Once lifted, the lubricator 110 can be moved laterally, off the wellbore central axis 122, such as by rotating or translating the lubricator 110 sideways or horizontally, such as shown in the transition from FIG. 3 to FIG. 4—whilst maintaining the lubricator 110 upright in a vertical orientation. In the example shown, the lubricator lifting apparatus 112 comprises a ring gear rotation system 134 for pivoting the lubricator 110 away from the wellbore's central axis 122, with the lubricator 110 shown rotated through 90° in the transition from FIG. 3 to FIG. 4, whilst maintaining the lubricator in an upright orientation. Accordingly, access can be gained to the wellhead 114, BOP 116 and the wellbore, such as for insertion/removal of equipment—along the central longitudinal axis 122 shown vacant above the wellhead in FIG. 4 with the lubricator 110 moved off to the side. FIG. 5 shows a side view of FIG. 4.

Once access is no longer required to the wellbore with the lubricator 110 lifted off the wellbore central axis 122, the lubricator 110 lifting process can be reversed, with the sequential reversal of the steps from FIG. 4 through FIG. 3 to FIG. 2: translating the lubricator 110 onto the central axis 122, lowering it 110 back onto the wellhead 114 for connection thereto-and subsequent (re)pressurisation.

It will be appreciated that a single lubricator lifting apparatus 112 may be associated with a single wellhead 114. Alternatively, the lubricator lifting apparatus 112 may be used at multiple wellheads 114. The lubricator lifting apparatus 112 may be readily transferable between wellheads, providing a quicker, cheaper, safer alternative to rigging-up a deck-based lifting device (e.g. a crane) for each wellhead 114. It will be appreciated that the bespoke lubricator lifting apparatus 112 shown here can be lifted onto and/or off a wellhead 114 in a single lifting operation, such as with an available rig/deck lifting device (e.g. derrick, crane, etc.). The lubricator lifting apparatus 112 can be lifted directly from a first wellhead 114 to a second wellhead (not shown) in a single lifting operation. In other examples (not shown), each wellhead 114 or lubricator 110 can be fitted, or retrofitted, with a lubricator lifting apparatus 110. Accordingly, each wellhead 114 can be made accessible with the lubricator 110 lifted therefrom 114 at any juncture, without requirement for transit and rig-up of a lifting device, such as the crane shown in FIG. 1—and optionally without any transit or rig-up of any lifting device, with the bespoke lubricator lifting apparatus 112 being effectively permanently available or installed.

With several wellheads on any given platform, there can be high potential for numerous operations, such as inspection and/or servicing/replacement (e.g. valve failures). As such, gaining access to the platform to repair failed valves can be a major challenge facing operators. When a slot in the platform schedule does become available, there is then further justification required as value-adding well-work is always a strong contender for these available slots. However, the system as shown here can provide for quicker operations, such as valve inspections, repairs or replacements. In general, this system here may provide the industry with an alternative, simplified, cheaper, quicker, lower risk, safer solution for lifting lubricators compared with current methods.

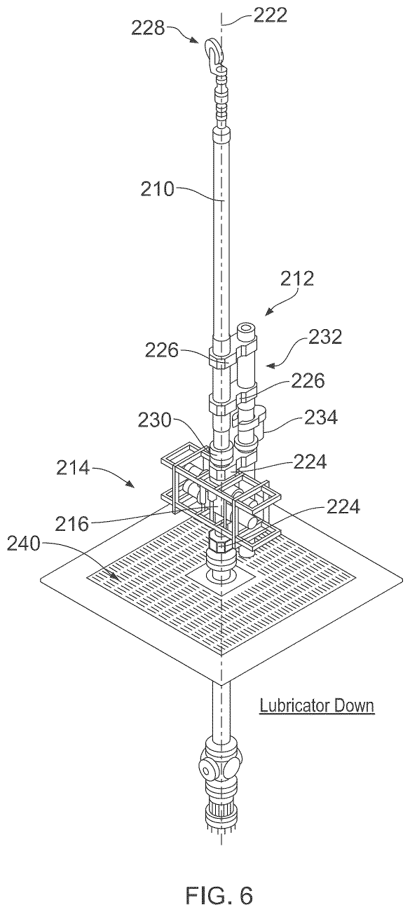

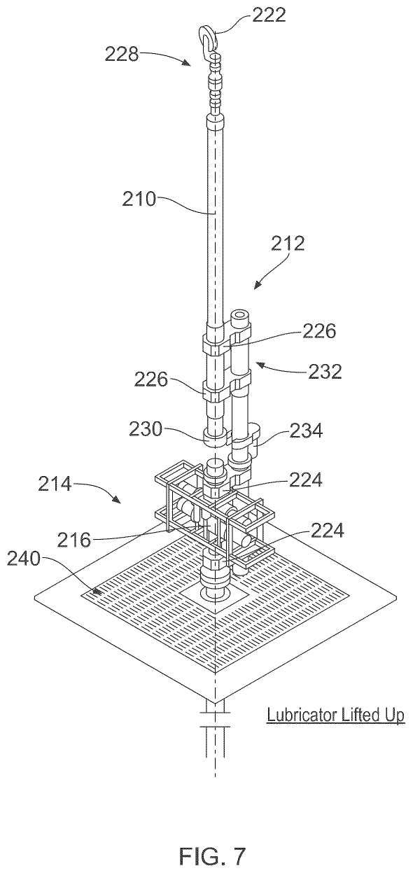

The lubricator lifting apparatus 212 of FIGS. 6, 7,8 and 8b, is generally similar to that 112 of FIG. 2, with similar features denoted with similar reference numerals, incremented by 100, noting that descriptions of each similar feature are not repeated here, for brevity and clarity. Accordingly, the lubricator lifting apparatus 212 is a single ram apparatus associated with a wellhead 214. The apparatus 212 is shown in FIGS. 6 through 9 in a ¾ view from above. The apparatus 212 shown in FIG. 6 is again shown with the lubricator lifting apparatus 212 attached to both the wellhead 214 and the lubricator 210. FIGS. 6 through 8 show a similar sequence of lifting the lubricator 210 and translating the lubricator 210 laterally off the centre line, whilst maintaining the lubricator 210 upright.

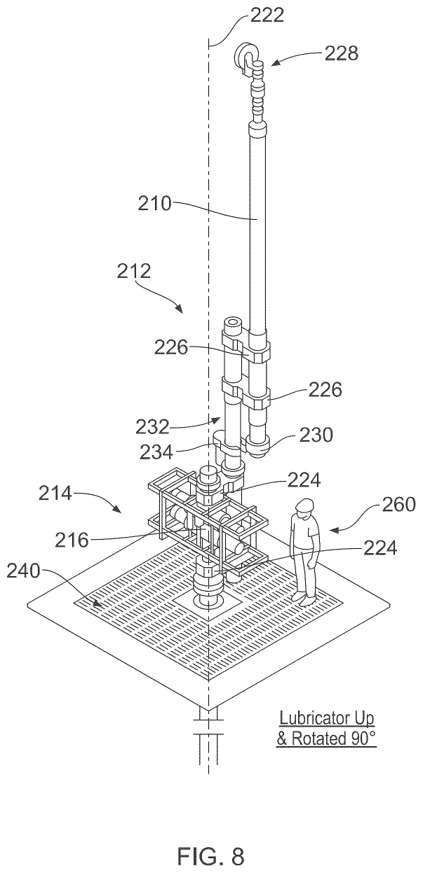

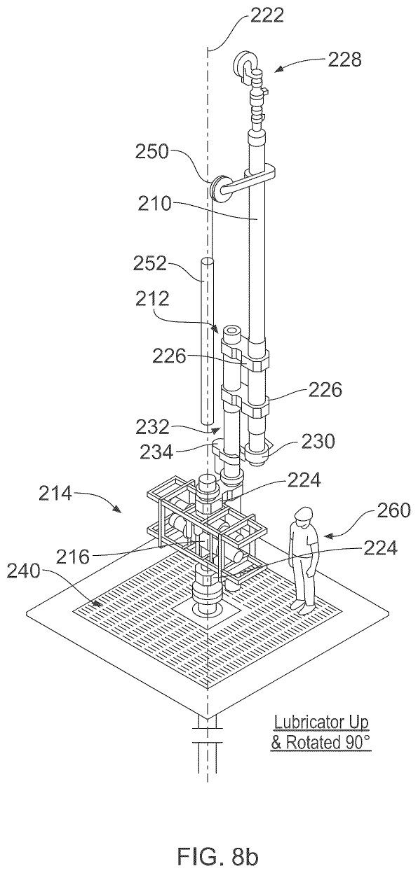

FIG. 8b shows an example of an operation with the lubricator 210 lifted and moved off the centre line 222. Here, the lubricator 210 itself is also used to suspend equipment for insertion/removal in/from the wellbore 214. A lifting device 250 (e.g. one or more or of a sheave, winch, reel or the like) can be mounted to the lubricator 210 itself, to allow suspension of tools 252 adjacent to the lubricator 210 on the axis 222 for insertion/removal to/from the wellhead 214. It will be appreciated that in other examples, a tool/line-lifting device 250 can be provided elsewhere—such as directly supported/mounted on the lubricator lifting apparatus 212 as such.

The system can be controlled by a hydraulic control panel (not shown), where pressures can be used to control piston position, such as by an operator 260 locally. The control panel can be fed from a hydraulic power unit which can provide sufficient flow and pressures (e.g. up to 10 ksi).

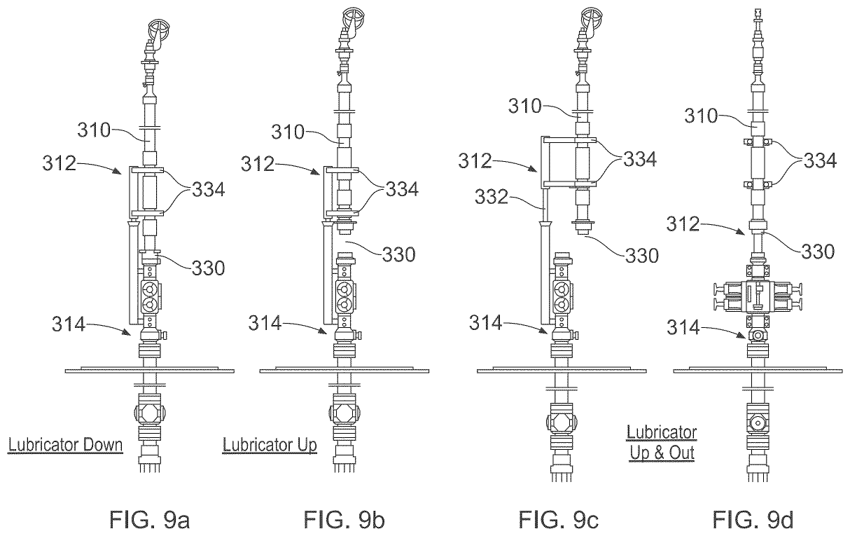

The lubricator lifting apparatus 312 of FIGS. 9a, 9b, 9c and 9d is generally similar to that 212 of FIG. 6, with similar features denoted with similar reference numerals, incremented by 100, noting that descriptions of each similar feature are not repeated here, for brevity and clarity. Accordingly, the lubricator lifting apparatus 312 is associated with a wellhead 314. Again here the apparatus 312 is a single ram lifting apparatus, with a single ram 332 for lifting the lubricator 310. The sequence of operation of the apparatus 312 through FIG. 9a, then 9b, then 9c is generally similar to the operation of the apparatus 212 through FIGS. 6, 7 and 8 respectively, with the lubricator 310 initially in a lowered position in FIG. 9a, then a raised position in FIG. 9b; and finally a raised and moved off the centreline position in FIG. 9c. FIG. 9d is a side view of FIG. 9c. Particularly in FIGS. 9c and 9d it can be seen that, rather than translated off the centreline with a rotational movement; the translation means 334 here are lateral pistons for moving the lubricator 310 off the centreline in an upright position using a linear horizontal movement.

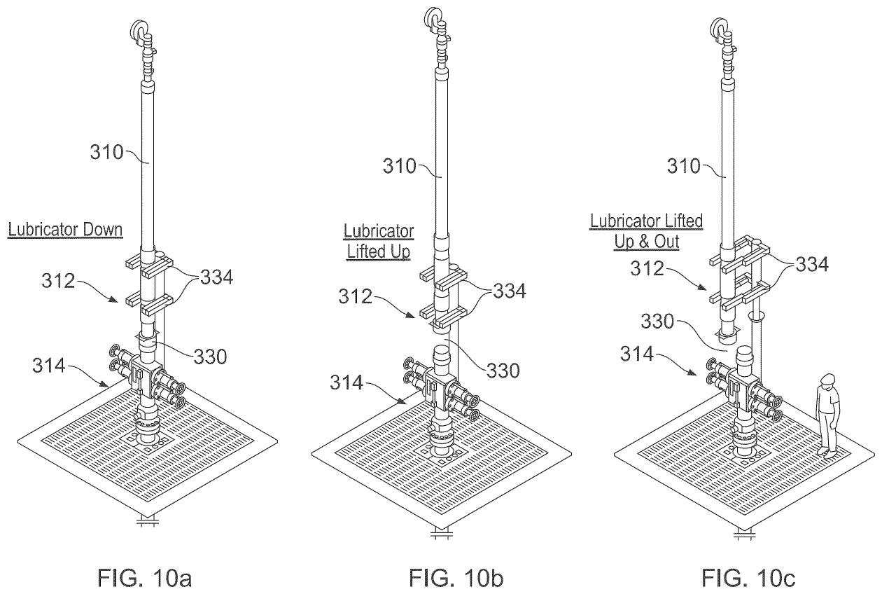

FIGS. 10a, 10b and 10c show the sequence of operation of the apparatus 312 corresponding to the sequence of FIGS. 9a, 9b and 9c.

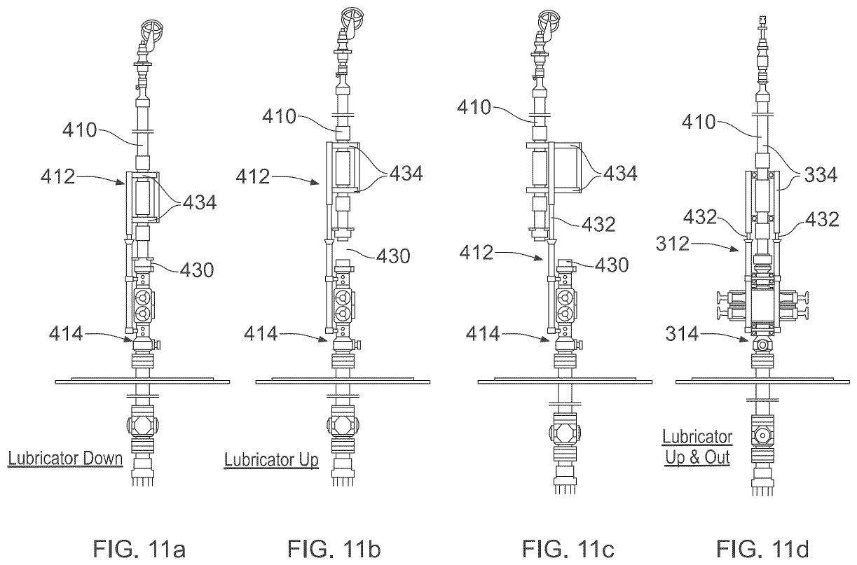

The lubricator lifting apparatus 412 of FIGS. 11a, 11b, 11c and 11d is generally similar to that 312 of FIG. 9, with similar features denoted with similar reference numerals, incremented by 100, noting that descriptions of each similar feature are not repeated here, for brevity and clarity. Accordingly, the lubricator lifting apparatus 412 is associated with a wellhead 414. However, here the apparatus 412 is a dual ram lifting apparatus, with a pair of rams 432 for lifting the lubricator 410. The sequence of operation of the apparatus 412 through FIG. 11a, then 11b, then 11c is generally similar to the operation of the apparatus 312 through FIGS. 9a, 9b and 9c respectively, with the lubricator 410 initially in a lowered position in FIG. 11a, then a raised position in FIG. 11b; and finally a raised and moved off the centreline position in FIG. 11c. Here, FIG. 11d is a side view of FIG. 11a. Particularly in FIG. 11d it can be seen that the pair of rams 432 operate to lift the lubricator 410.

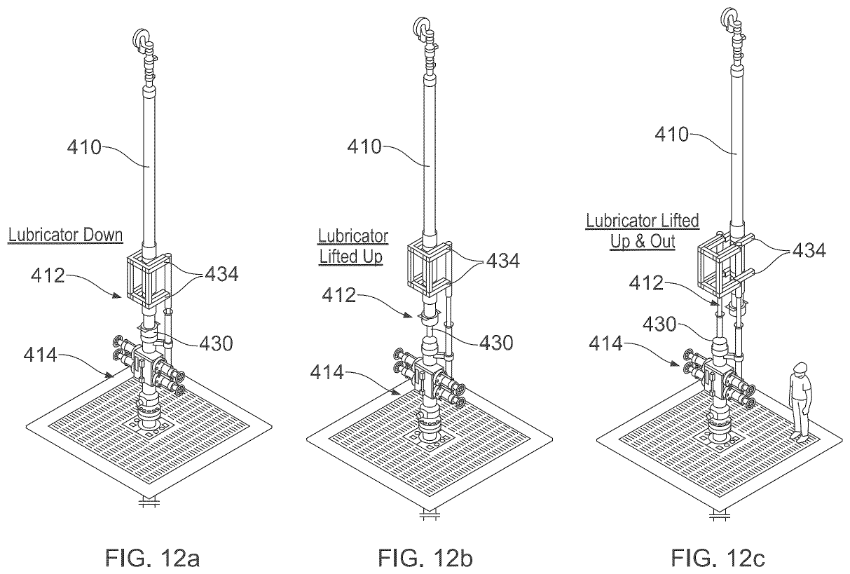

FIGS. 12a, 12b and 12c show the sequence of operation of the apparatus 412 corresponding to the sequence of FIGS. 11a, 11b and 11c.

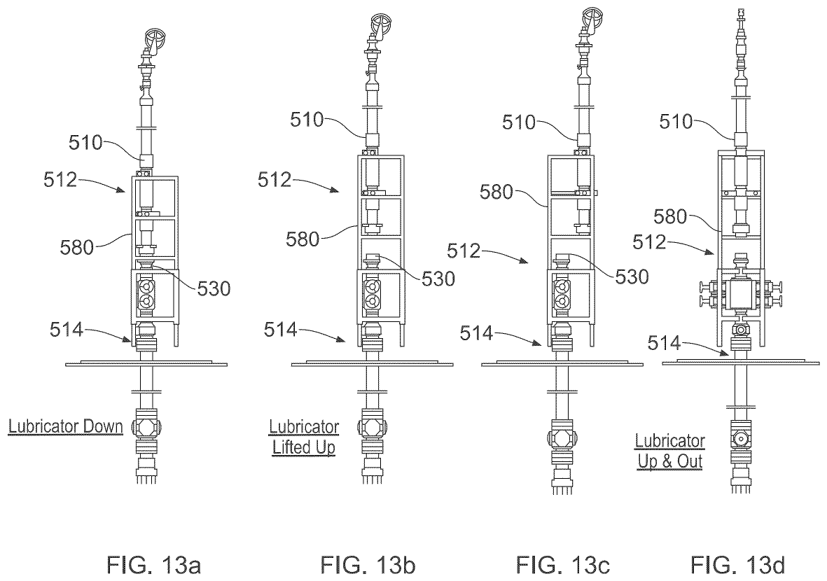

The lubricator lifting apparatus 512 of FIGS. 13a, 13b, 13c and 13d is generally similar to that 412 of FIGS. 11a, 11b, 11c and 11d, with similar features denoted with similar reference numerals, incremented by 100, noting that descriptions of each similar feature are not repeated here, for brevity and clarity. Accordingly, the lubricator lifting apparatus 512 is associated with a wellhead 514. Again, here the apparatus 512 is a dual ram lifting apparatus, with a pair of rams 532 for lifting the lubricator 510. The sequence of operation of the apparatus 512 through FIG. 13a, then 13b, then 13c is generally similar to the operation of the apparatus 412 through FIGS. 11a, 11b and 11c respectively, with the lubricator 510 initially in a lowered position in FIG. 13 a, then a raised position in FIG. 13b; and finally a raised and moved off the centreline position in FIG. 13c. Here, FIG. 13d is a side view of FIG. 13c. The apparatus 512 shown here comprises a support frame 580 that can be used to provide additional support, such as when the apparatus 512 is stored (e.g. upright, or lain down on deck or for transportation, such as in a basket, etc.).

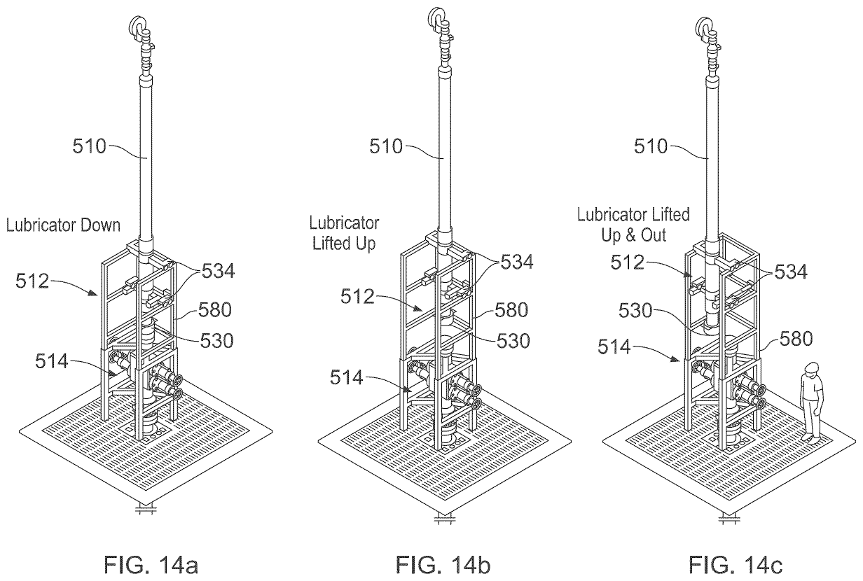

FIGS. 14a, 14b and 14c show the sequence of operation of the apparatus 512 corresponding to the sequence of FIGS. 11a, 11b and 11c.

The lubricator lifting apparatus 512 is configured to lift the lubricator 510 vertically (e.g. up and/or down); and in at least some cases to lift the apparatus 510 with the toolstring supported therein or thereon (see e.g. FIG. 8b). The lubricator lifting apparatus 512 is configured to allow lifted translation of the lubricator 510, such as lateral translation of the apparatus 410 to/from above the well (e.g. onto and/or off the wellhead 496, 498). The lubricator lifting apparatus 512 here comprises a powered hydraulic lifting mechanism, which enables tool changeover/s without an overhead lifting machine, such as a crane, derrick or the like. Here, the lubricator lifting apparatus 512 is configured to lift the lubricator by approximately 50 cm vertically above the wellhead BOP 516 (when disconnected). Once raised by the lubricator lifting apparatus 512, the lubricator 510 can be translated horizontally with a hydraulic lateral drive by around 30 cm-50 cm—sufficient to allow access to the top of the BOP 516. The lifting process is effectively reversed to position the lubricator 510 back on the wellhead. Here, the lubricator lifting apparatus 512 is hydraulically powered, controlled by the operator from the control unit to laterally translate the lubricator 510 horizontally and (e.g. to push the lubricator 510 back over the BOP and then lower down to allow connection make up).

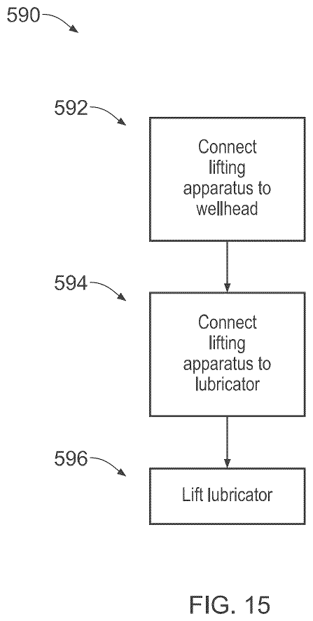

FIG. 15 shows an example method 590 of use of the lifting apparatus 512. In one example, the lifting apparatus 512 is connected to the wellhead 514 in a first step 592, then connected to the lubricator 510 in a second step 594; and then the lubricator 510 is lifted in a third step 596. In other examples, the lifting apparatus 512 is connected to the lubricator 510 prior to connection to the wellhead 514. In at least some examples, the lifting apparatus 512 is connected to the lubricator 510 before the lubricator 512 is connected to the wellhead 514.

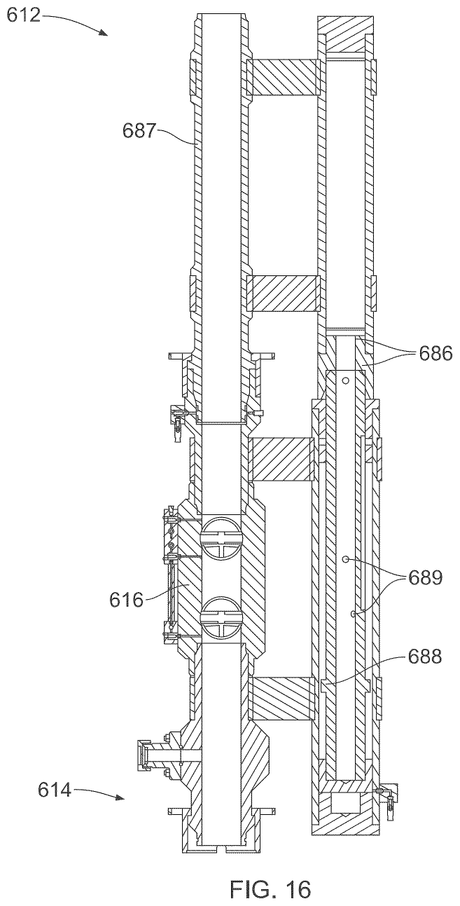

FIG. 16 shows an overview of a lifting/rotation system 612, which is generally similar to that 512 of FIGS. 41a, 41b and 14c, with similar features denoted with similar reference numerals, incremented by 100, noting that descriptions of each similar feature are not repeated here, for brevity and clarity. Here, shoulders 686 are shown for conveying the load supported by the apparatus 612 to lift the lubricator (which it shall be appreciated can be connected to the sub 687) off/above the wellhead 614, separated from the BOP 616. The relatively moving parts, such as the cylindrical portions or tubulars are provided with bearing strips, preventing metal on metal contact and reducing friction and wear. A positive lift stop 688 is provided for limiting travel of the lifting apparatus 612 to a maximum desired stroke. Holes 689 for locking pins are provided to enable locking of the apparatus 612 with the lubricator lifted (selectively in a lifted straight or a lifted rotated position).

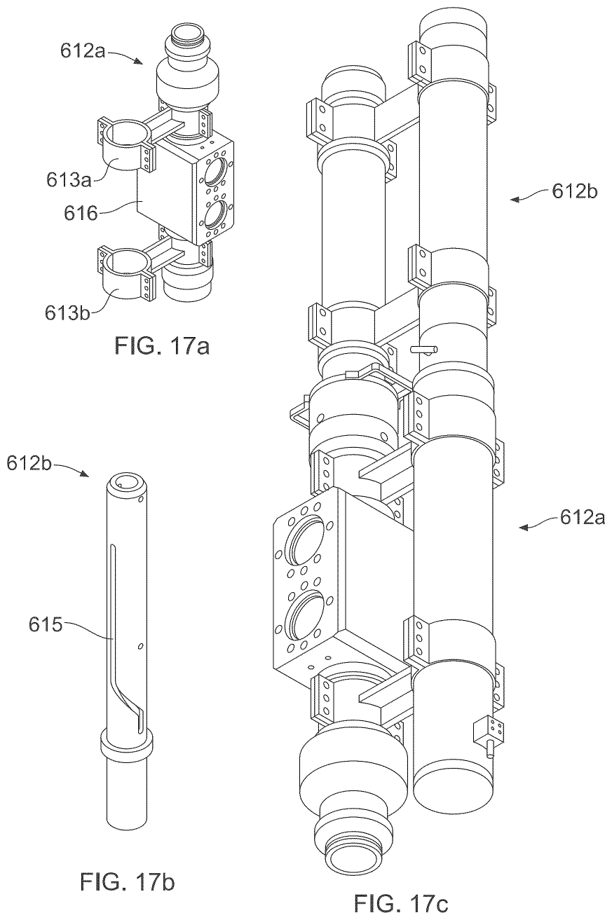

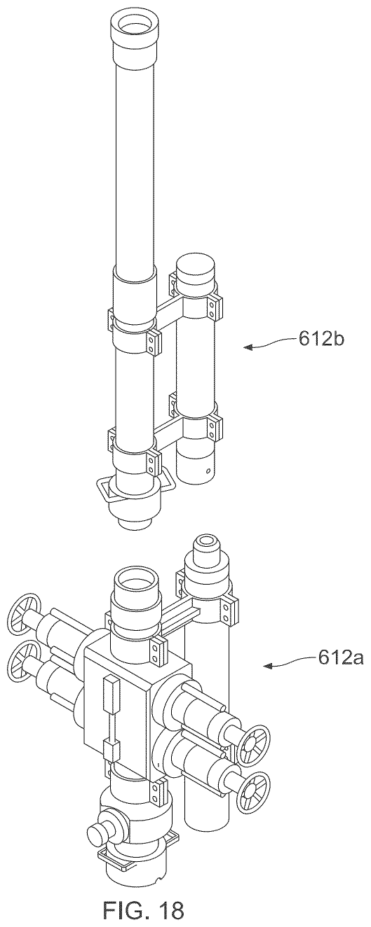

FIG. 17a shows a first portion 612a of the apparatus 612 of FIG. 16 positioned about a portion of the BOP 616. Here, a pair of clamps 613a, 613b are shown for attaching the lifting apparatus 612 to the wellhead 614. FIG. 17b shows a second portion 612b of the apparatus 612, illustrating a keyway 615 for receiving a guidepin for controlling the rotational movement of the lubricator off the centerline as it is lifted—towards the top of the apparatus's 612 stroke as shown here. FIG. 17c shows the assembled portions 612a, 612b of the apparatus, with FIG. 18 shows the assembled apparatus 612 at the wellhead 614, with the portions 612a, 612b separated. It will be appreciated that the portions can be separated, such as for transit to the wellhead 614. Connecting the portions can be with suitable connections, such as with locking pins and/or screwthreads as appropriate.

The methods of use here can represent significant time and cost saving compared to conventional operations. For example, the method of use here comprises lifting the lubricator without requiring a crane or lifting device to be rigged up on the deck adjacent the wellhead. The lubricating lifting apparatus here effectively pushes up the lubricator for lifting, rather than pulling. Accordingly, the lubricator lifting apparatus here does not need to be taller than the lubricator. Providing a lifting apparatus of shorter length than conventionally (e.g. shorter than the lubricator itself) can make transportation, storage and/or rig-up operations much easier, safer and quicker.

It will be appreciated that where the PCE lifting apparatus and the PCE being lifted shown here is in the form of a lubricator lifting apparatus 112 and a lubricator 110; in other methods and embodiments other PCE or portions thereof can be lifted. For example, the BOP 616 can be lifted in a generally similar method, with a PCE lifting apparatus 612 in the form of a BOP lifting apparatus, mounted below the BOPE 612 and also attached thereto-such that a connection below the BOPE 612 may be broken with the apparatus and methods disclosed herein. It will be appreciated that the BOP 612 could be lifted with, or without, the lubricator 610 attached thereabove.

Although not shown here, it will be appreciated that the lubricator lifting apparatus can be operated using a control unit. The lubricator lifting apparatus can be configured for operation/control remotely from the lubricator lifting apparatus, such as with the lubricator lifting apparatus being operable by an operator from a deck-based control unit spaced from the lubricator lifting apparatus. The control unit can be hard-wired to the lubricator lifting apparatus, such as to directly control hydraulic and/or electrical components of the lubricator lifting apparatus.

It will be appreciated that embodiments of the present invention can be realised in the form of hardware, software or a combination of hardware and software. Any such software may be stored in the form of volatile or non-volatile storage such as, for example, a storage device like a ROM, whether erasable or rewritable or not, or in the form of memory such as, for example, RAM, memory chips, device or integrated circuits or on an optically or magnetically readable medium such as, for example, a CD, DVD, magnetic disk or magnetic tape. It will be appreciated that the storage devices and storage media are embodiments of machine-readable storage that are suitable for storing a program or programs that, when executed, implement embodiments of the present invention. Accordingly, embodiments provide a program comprising code for implementing a system or method as disclosed in any aspect, example, claim or embodiment of this disclosure, and a machine-readable storage storing such a program. Still further, embodiments of the present disclosure may be conveyed electronically via any medium such as a communication signal carried over a wired or wireless connection and embodiments suitably encompass the same.

All of the features disclosed in this specification (including any accompanying claims, abstract and drawings), and/or all of the steps of any method or process so disclosed, may be combined in any combination, except combinations where at least some of such features and/or steps are mutually exclusive. The applicant indicates that aspects of the present disclosure may consist of any such individual feature or combination of features. It should be understood that the embodiments described herein are merely exemplary and that various modifications may be made thereto without departing from the scope of the disclosure. For example, it will be appreciated that although shown here with a pair of clamps on each of the lower and upper wellhead portions (the upper wellhead portion comprising the lubricator being lifted), in other embodiments other attachments are provided, such as singular connections rather than pairs.

Each feature disclosed in this specification (including any accompanying claims, abstract and drawings), may be replaced by alternative features serving the same, equivalent or similar purpose, unless expressly stated otherwise. Thus, unless expressly stated otherwise, each feature disclosed is one example only of a generic series of equivalent or similar features.

The invention is not restricted to the details of any foregoing embodiments. The invention extends to any novel one, or any novel combination, of the features disclosed in this specification (including any accompanying claims, abstract and drawings), or to any novel one, or any novel combination, of the steps of any method or process so disclosed. The claims should not be construed to cover merely the foregoing embodiments, but also any embodiments which fall within the scope of the claims.

1. A method of lifting a wellhead apparatus comprising a PCE (pressure control equipment), the method comprising lifting the PCE using a PCE lifting apparatus, with the PCE lifting apparatus being supported on the wellhead apparatus.

2. The method of claim 1, wherein the method comprises breaking a connection in wellhead equipment, the method comprising lifting a portion of the wellhead equipment using the PCE lifting apparatus to break the connection, wherein the PCE lifting apparatus is supported on the wellhead apparatus throughout lifting of the portion of the wellhead equipment, and wherein the PCE comprises a lubricator and the PCE lifting apparatus comprises a lubricator lifting apparatus.

3. (canceled)

4. The method of claim 1, wherein the PCE lifting apparatus is entirely and directly supported on the wellhead apparatus, such that the PCE can be lifted off the wellhead apparatus while the wellhead apparatus still bears a weight of the PCE during lifting and thereafter, and wherein the method comprises lifting the PCE without transferring weight of the PCE off the wellhead apparatus.

5. The method of claim 1, wherein the method comprises creating a separation between the PCE and the wellhead apparatus therebelow while supporting a weight of the PCE on the wellhead apparatus.

6. (canceled)

7. The method of claim 1, wherein the method comprises: supporting both the PCE lifting apparatus and the PCE from below; and/or lifting the PCE without suspending the PCE; and/or lifting the PCE without any flexible tensile members.

8. The method of claim 1, wherein the method comprises attaching the PCE lifting apparatus to the wellhead apparatus below a connection to be broken, and additionally attaching the PCE lifting apparatus above the connection to be broken, such that the PCE lifting apparatus is attached both above and below the connection to be broken; and wherein the PCE lifting apparatus remains attached above and below the connection being broken throughout the breaking of the connection; and the PCE lifting apparatus transfers at least a portion of a weight of the PCE to the wellhead apparatus after breaking of the connection.

9. (canceled)

10. The method of claim 8, wherein an upper attachment, above the connection, is to the PCE, or at least equipment associated therewith, to be lifted together with the PCE; and a lower attachment, below the connection, is to, at or around a BOP or a Xmas tree.

11. (canceled)

12. The method of claim 1, wherein the method comprises moving the PCE off a central axis of a wellbore, by laterally translating the PCE away from a central longitudinal axis of the wellbore while maintaining the PCE upright, and the method comprises supporting all of a weight of the PCE and a toolstring on the wellhead apparatus throughout.

13. (canceled)

14. The method of claim 1, wherein the method comprises locking the PCE in a position, selected from one or more of: a lifted position; a lateral position laterally moved off a centreline; a rotated position, with the PCE rotated off the centreline.

15. The method of claim 1, wherein the method comprises placing or replacing the PCE on the wellhead apparatus, the method comprising lowering the PCE for connection to the wellhead apparatus with a weight of the PCE supported on the wellhead apparatus throughout.

16. The method of claim 1, wherein the method comprises accessing a wellbore and performing an operation, changeout and/or intervention; without supporting the PCE on a deck, a deck-mounted crane, a derrick, or a winch.

17. The method of claim 1, wherein the method comprises lifting the PCE lifting apparatus onto the wellhead apparatus in a single lift operation; and transferring the PCE lifting apparatus between wells/wellheads without being fully rigged down.

18. A wellhead PCE lifting apparatus for lifting a PCE (pressure control equipment), wherein the PCE lifting apparatus is configured to be connected to a wellhead such that the PCE lifting apparatus is supported on the wellhead.

19. The PCE lifting apparatus of claim 18, wherein the PCE lifting apparatus comprises a first fitting, being a first clamp, for connection to the wellhead such that the PCE lifting apparatus is configured to be connected to the wellhead and/or a Xmas tree and/or a BOP.

20. The PCE lifting apparatus of claim 19, wherein the PCE lifting apparatus comprises the first fitting on a lower portion for attachment to the wellhead below the PCE.

21. The PCE lifting apparatus of claim 19, wherein the PCE lifting apparatus comprises a second fitting, being a second clamp, for connection to the PCE, or at least a portion of the wellhead to be lifted with the PCE, the second fitting being on an upper portion such that the PCE lifting apparatus is configured to be attached to the wellhead below the PCE via the first fitting; and attached to the PCE above the wellhead via the second fitting; whereby the PCE lifting apparatus is configured to be attached to the wellhead below a connection to be broken to lift the PCE; and also above the connection, to the PCE.

22. The PCE lifting apparatus of claim 18, wherein the PCE lifting apparatus comprises a hydraulic actuator with a piston and a cylinder housing the piston, wherein one of the cylinder and the piston is configured to be fixably mounted to the wellhead, wherein the cylinder forms an exterior housing of the PCE lifting apparatus and a lower portion of the piston is configured to be connected to the wellhead such that the PCE lifting apparatus is attachable to the wellhead below the PCE.

23. (canceled)

24. The PCE lifting apparatus of claim 22, wherein the PCE lifting apparatus is configured to actively control a lateral position of the piston, to laterally drive the piston so as to move the lateral position horizontally relative to a longitudinal axis of the piston so that a PCE lifted by the PCE lifting apparatus is moveable on and/or off a centerline.

25. The PCE lifting apparatus of claim 18, wherein the PCE lifting apparatus comprises a support frame for supporting the PCE lifting apparatus and/or the PCE, the support frame being provided with the PCE lifting apparatus, as part of or at least connected or mounted to the PCE lifting apparatus, the support frame being for supporting the PCE lifting apparatus when disconnected from the wellhead.

26. (canceled)

27. A wellhead comprising the lifting apparatus of claim 18, with the PCE lifting apparatus attached to the wellhead such that the PCE lifting apparatus is entirely supported on the wellhead during any lifting operations performed by the PCE lifting apparatus, without transferring any weight to a deck or deck-based equipment, being a deck-based crane, derrick, or a winch.
